(19) United States
(12) Patent Application Publication
(10) Pub. No.: US 2008/0300408 A1
(43) Pub. Date: Dec. 4, 2008

(54) Process for Preparing a Pure Polymorphic Form of 3-Pyridyl-1-Hydroxyethylidine-1, 1-Bisphosphonic Acid Sodium Salt

(75) Inventors: Satish Chandra Pandey, Noida (IN); Khushi Ram, Noida (IN); Manoj Kumar Singh, Noida (IN); Rajesh Kumar Thaper, Noida (IN); Sushil Kumar Dubey, Noida (IN)

Correspondence Address: WORKMAN NYDEGGER, 60 EAST SOUTH TEMPLE, 1000 EAGLE GATE TOWER, SALT LAKE CITY, UT, 84111, US

(73) Assignee: JUBILANT ORGANOSYS LIMITED, Noida, Uttar Pradesh (IN)

(21) Appl. No.: 11/718,857

(22) PCT Filed: Aug. 21, 2006
(86) PCT No.: PCT/IN04/00345

§ 371 Date: Jul. 16, 2008

(51) Int. Cl. C07F 9/58

(52) U.S. Cl. 546/22

(57) ABSTRACT

This process in general relates to the novel process for preparing polymorphic forms of 3-pyridyl-1-hydroxyethylidine-1,1-bisphosphonic acid sodium salt (Risedronate Sodium) in particular risedronate Form A and B employing a solvent system in an appropriate ratio. An improved process for preparation of risedronic acid is also disclosed in the present invention.

### FIELD OF THE INVENTION

This invention, in general, relates to a process for preparing polymorphic forms of 3-pyridyl-1-hydroxyethylidine-1,1-bisphosphonic acid sodium salt (Risedronate Sodium). More specifically, but without restriction to the particular embodiments hereinafter described in accordance with the best mode of practice, the present invention provides a novel process for preparation of risedronate Form A and B employing a solvent system in an appropriate ratio.

### BACKGROUND OF THE INVENTION

3-pyridyl-1-hydroxyethylidine-1,1-bisphosphonic acid sodium salt (Risedronate Sodium), is an oral bisphosphonate that significantly reduces the risk of new vertebral fractures as well as used in the prevention of steroid-induced osteoporosis. Risedronate is also more effective than etidronate in the treatment of Paget's disease.

European Patent No. 186,405 and its U.S. Pat. No. 5,583,122 describe the preparation of risedronic acid by reaction of 3-pyridyl acetic acid with phosphorous acid and phosphorous trichloride in chlorobenzene to obtain a viscous oily intermediate. The reaction mixture is cooled in ice bath converting viscous oil to semi-solid material and decanting the chlorobenzene from the solidified material. The semi-solid material further undergoes hydrolysis in presence of added water followed by the crystallization of product by adding methanol to obtain only 52% yield. This process is complicated, as the reaction mixture being in semi-solid form, creates difficulty in safe scale up. The decantation of the chlorobenzene is also a difficult process at the plant scale.

U.S. Pat. No. 6,410,520 discloses the existence of risedronate sodium in three hydration states: hemipentahydrate, monohydrate and anhydrous. Mono and hemipentahydrates are prepared by selective crystallization. However, the characterization data for these forms are not reported in the said patent. The patent also discloses selective crystallization of mono and hemipentahydrates by heating an aqueous solution of 3-pyridyl-1-hydroxyethylidine-1,1-bisphosphonic acid sodium from about 45° C. to about 75° C. and crystallization of product by the addition of isopropanol, and cooling with different cooling ramp.

PCT Application No. WO 03/086,355 and its US equivalent U.S. Patent Application No. 2003/0,195,170 disclose various crystalline forms e.g. B, C, D, E, F, G & H of risedronate sodium and methods for their preparations using alcoholic solvents at reflux temperature for precipitation of the product from aqueous layer. The patent discloses XRD, TGA and IR of various forms of risedronate sodium prepared by different ratio of alcoholic solvents (i.e. Isopropanol, Ethanol and Methanol) in water.

The present invention discloses a convenient, industrially feasible and efficient process for the preparation of risedronate sodium pure Form A and Form B without the contamination of other forms

### SUMMARY OF THE INVENTION

In accordance with the principal aspect of the present invention, there is provided a novel process for preparing a pure form of polymorphs of 3-pyridyl-1-hydroxyethylidine-1,1-bisphosphonic acid sodium salt (Risedronate Sodium) to improve upon limitations in the prior art. The process comprises of selecting the solvent in appropriate composition and providing a suitable solvent system at room temperature for obtaining the polymorphs of risedronate sodium.

In accordance with another aspect of the present invention, there is provided a novel process for preparing pure polymorphic form of 3-pyridyl-1-hydroxyethylidine-1,1-bisphosphonic acid sodium salt (Risedronate Sodium), in particular to prepare the polymorphic Form A and B employing suitable solvent system comprising organic solvent in appropriate composition at room temperature.

In yet another aspect of present invention, a process for the preparation of polymorphic Form A and Form B of risedronate sodium is provided by using different solvents and solvent systems selected from the group consisting of alcohol, nitrile, ketone, ether, ester and amide at room temperature.

In a further aspect of the present invention, there is provided a process where non-alcoholic solvents are used optionally at reflux temperature for obtaining the polymorphs of risedronate sodium.

In accordance with still another aspect, there is provided a novel process for preparing a pure form of polymorphs of 3-pyridyl-1-hydroxyethylidine-1,1-bisphosphonic acid sodium salt (Risedronate Sodium), wherein the process comprises of treating 3-pyridyl acetic acid with phosphorous acid and phosphorous trichloride in the presence of a solvent such as chlorobenzene, hydrolyzing the same using water, followed by methanol addition and collecting the solid as risedronic acid and suspending solid risedronic acid in water and adding sodium base into the same to prepare risedronate sodium, adding an organic solvent or a mixture of organic solvents of varying composition at room temperature to obtain the pure polymorphic form of risedronate sodium.

In accordance with still another aspect of the present invention, there is provided an improved process for preparation of risedronic acid used herein the preparation of risedronate sodium in very high yield. The process comprises of reacting 3-pyridyl acetic acid with phosphorous acid and phosphorous trichloride in the presence of chlorobenzene, adding water to the reaction mixture without decanting or separating chlorobenzene, heating the resultant reaction mixture and adding the methanol into the same to obtain solid risedronic acid in very high yield, which is further used for the preparation of the risedronate sodium and its polymorphs according to the above mentioned processes.

### BRIEF DESCRIPTION OF THE DRAWING FIGURES

Further objects of the present invention together with additional features contributing thereto and advantages accruing there from will be apparent from the following description of preferred embodiments of the invention which are shown in the accompanying drawing figures, wherein:

FIG. 1 shows a graphical representation of XRD of Form A

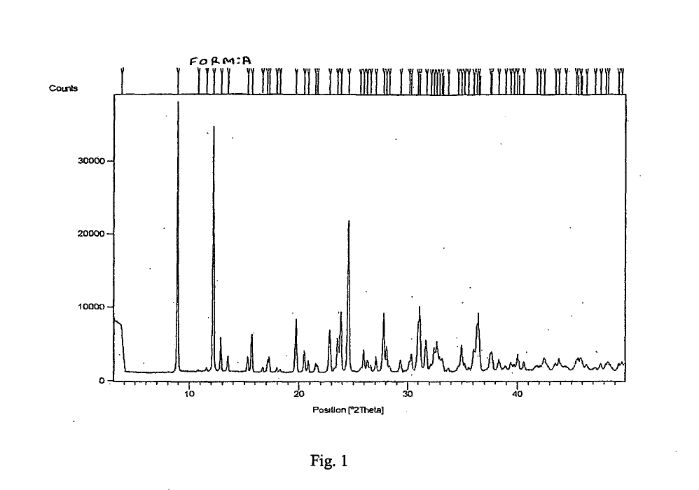

FIG. 2 shows a graphical representation of TGA of Form A

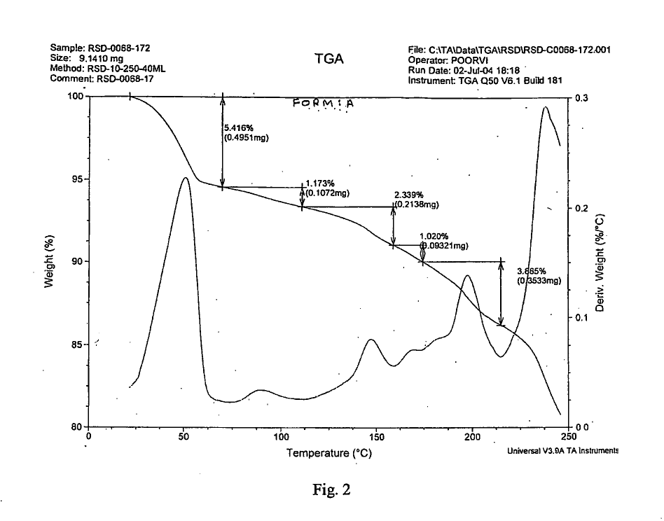

FIG. 3 shows a graphical representation of XRD of Form B

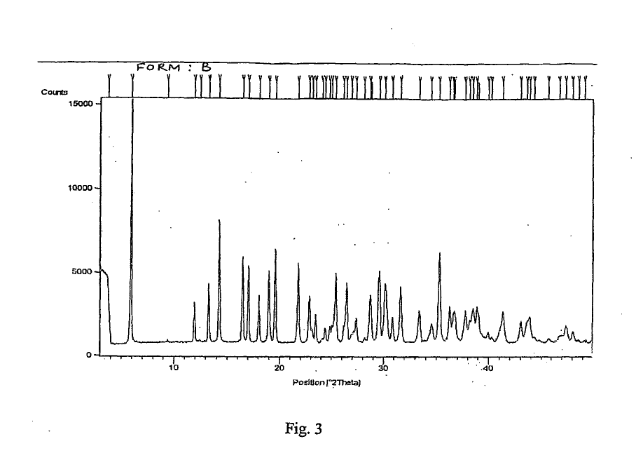

FIG. 4 shows a graphical representation of TGA of Form B

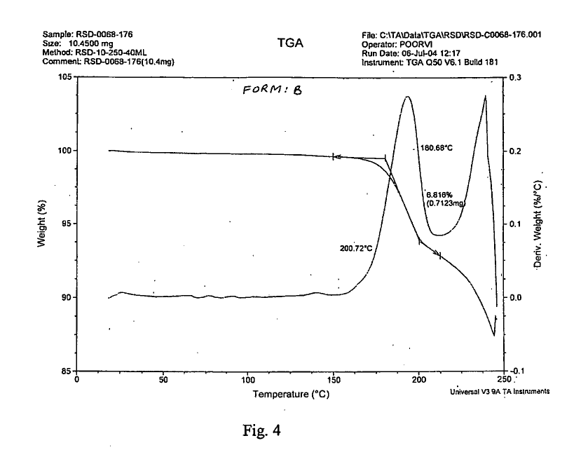

FIG. 5 shows a graphical representation of XRD of risedronic acid

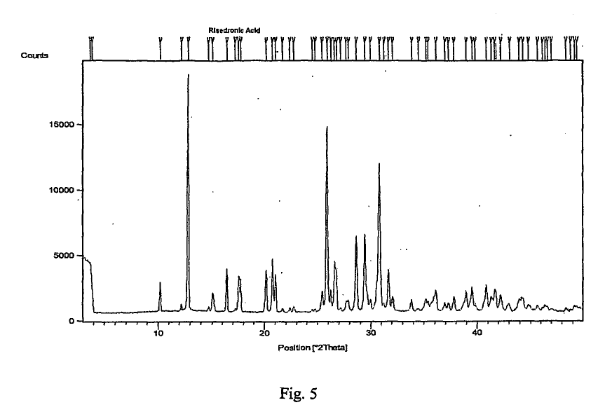

### DETAILED DESCRIPTION OF THE INVENTION

The present invention describes a convenient, industrially feasible and efficient process for the preparation of different forms of mono sodium salt of the risedronic acid i.e., 1-hydroxy-2-(3-pyridyl)ethylidinebisphosphonic acid monosodium salt, without the contamination of other forms. The reactions are performed at room temperature that saves lots of energy and time in the formation of the product.

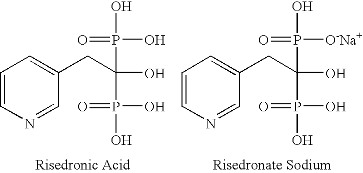

The present invention provides a process for the preparation of polymorphic forms of risedronate sodium specifically Form A and Form B by treating 3-pyridyl acetic acid with phosphorous acid and phosphorous trichloride in the presence of a solvent such as chlorobenzene, hydrolyzing the same using water, followed by methanol addition and collecting the resultant solid i.e. risedronic acid, further followed by preparation of sodium salt in water and then isolation by adding different solvent and solvent systems at room temperature or reflux temperature.

The preparation of risedronate sodium described herein is also a preferred mode of the present invention, wherein the process comprises the step of stirring a combination of risedronic acid, a sodium base in water and a water miscible or partially miscible solvent or the mixture of said solvents at room temperature to get solid risedronate sodium.

The process provides for preparation of risedronate sodium Form A, comprising the step of stirring a combination of risedronic acid, a sodium base in water and adding a water miscible or partially miscible or the mixture of said solvents at room temperature to get risedronate sodium Form A.

As used herein, water miscible or partially miscible solvent for preparing risedronate sodium Form A are ketonic solvents (about 15-50% ketone in resulting reaction solution) referred to compounds with general formula R(C═O)R′ wherein R or R′ are linear or branched alkyl group having 1-6 carbon atoms, especially acetone (about 20%-40%), methyl ethyl ketone (about 20%-50%), methyl isobutyl ketone (about 15%-20%) or the mixture of ketones (about 15%-50%). Optionally the addition of organic solvent is done at reflux temperature and crystallization starts at 80-90° C.

As used herein, water miscible or partially miscible solvents for preparing risedronate sodium Form A are nitrites (about 15%-40% nitrile in resulting reaction solution) with general formula R—CN wherein R is a linear or branched alkyl group having 1-6 carbons especially acetonitrile (about 15%-40%). Optionally the addition of organic solvent is done at reflux temperature and crystallization starts at 80-90° C.

As used herein, water miscible or partially miscible solvents for preparing risedronate sodium Form A are ethereal solvents (about 15%-40% ether in resulting reaction solution) preferably refer to cyclic ethers, having 4-6 carbons and/or one or more oxygen atoms, especially tetrahydrofuran (about 15-40%), dioxanes (about 15%-20%) or the mixture of ethers (about 15%-25%). Optionally the addition of organic solvent is done at reflux temperature and crystallization starts at 80-90° C.

As used herein, solvents which are partially miscible solvents for preparing risedronate sodium Form A are esters (about 20%-50% ester in resulting reaction solution) which refer to compounds with general formula R(C═O)OR′ wherein R or R′ are a linear or branched alkyl group having 1-6 carbons, especially ethyl acetate (about 20%-50%). Optionally the addition of organic solvent is done at reflux temperature and crystallization starts at 80-90° C.

As used herein, water miscible or partially miscible solvents for preparing risedronate sodium Form A are amides (about 15%-20% amide in resulting reaction solution) which refer to compounds with general formula R(C═O)NR′R″ wherein R, R′ or R″ are a linear or branched alkyl group having 1-4 carbons or cyclic amide especially dimethyl formamide (about 15%-20% amide), dimethyl acetamide (about 15%-20% amide), 1-methyl-2-pyrrolidone (about 15%-20% amide) or the mixture of amides (about 15%-20%). Optionally the addition of organic solvent is done at reflux temperature and crystallization starts at 80-90° C.

As used herein, water miscible or partially miscible solvents for preparing risedronate sodium form A are alcohols (about 15%-40% alcohol in resulting reaction solution) referring to compounds with general formula R—OH wherein R is a linear or branched alkyl group having 1-8 carbons, especially ethanol (about 15%-25%), methanol (about 15%-25%), isopropanol (about 15%-40%) or the mixture of alcohols (about 15%-25%).

The mixture of solvent as used herein for preparing risedronate sodium Form A in the present invention is selected from the group consisting of alcohols, amides, esters, ethers, ketones and nitrites in different proportion (about 15%-60% solvent) at room temperature.

Further, the present invention relates to a process for preparation of risedronate sodium Form. B, comprising the step of stirring a combination of risedronic acid, a sodium base in water and adding water miscible or partially miscible cyclic ethereal solvent (about 40%-75% ether in resulting reaction solution) at room temperature, especially tetrahydrofuran (about 50%-70%), dioxanes (about 40%-75%) or the mixture of ethers (about 50%-75%).

The water miscible or partially miscible solvents used in the preparation of Form B risedronate sodium are amidic solvents (about 40%-60% amide in resulting reaction solution), especially dimethyl formamide (about 40%-60%), dimethyl acetamide (about 40%-60% amide), 1-methyl-2-pyrrolidone (about 40%-60%) or the mixture of amides (about 40%-60%). Optionally the addition of organic solvent is done at reflux temperature and crystallization starts at 80-90° C.

The water miscible or partially miscible solvents used in the preparation of Form B risedronate sodium are alcoholic solvent (about 40%-80% alcohol in resulting reaction solution) especially ethanol (about 40-80%), methanol (about 40%-75%), isopropanol (about 55%-75%) or the mixture of alcohol (about 40%-75%).

As used herein, with respect to a measured quantity, the term “about” indicates variation in the measured quantity as would be expected by the skilled artisan making the measurement or determination and exercising a level of care commensurate with the objective of the measurement and the precision of the measuring apparatus being used.

As used herein, the term sodium base refers to a base having sodium as cation, preferably, sodium hydroxide, sodium carbonate, sodium alkoxide (wherein alkyl contains C₁-C₆ carbon atoms) and sodium bicarbonate. Most preferably, sodium hydroxide is used as the sodium base.

As used herein, in connection with liquids that are mixture, v/v and volume/volume refer to the ratio of volumes of liquids (e.g. organic solvents and water) that are combined to make the liquid. Thus, 50/50 v/v refers to a mixture made by combining approximately equal volumes of liquids.

As used herein, in connection with organic solvents, the various solvents e.g. alcohols, amides, ethers, esters and nitriles individually or a mixture of any of these solvents or all of these solvents in different ratios are used.

Further, the present invention relates to a process for the preparation of risedronic acid in very high yield by the reaction of 3-pyridyl acetic acid with phosphorous acid and phosphorous trichloride in chlorobenzene and adding water to the reaction mixture without decanting or separating chlorobenzene. The reaction mixture is further heated and methanol is added into it to get solid risedronic acid. In this step, addition of water without decanting chlorobenzene makes the process simpler and surprisingly improves the yield drastically (>95%). Not only decanting of chlorobenzene from the viscous mass is a tough operation at large scale but also results into the loss in yield of product risedronic acid.

The examples mentioned below explain all the aspects of the present invention. The examples are given to illustrate the details of the invention and should not be construed to limit the scope of the present invention.

### EXAMPLE 1

### Preparation of Risedronic Acid

3-Pyridyl acetic acid (50 g), phosphorous acid (104 g) and chlorobenzene (500 ml) were taken in a five liter four necked round bottom flask fitted with boiling water bath, mechanical stirrer, condenser and thermometer pocket and allowed to stir at 90-95° C. Phosphorus trichloride (112 ml) was added in reaction mixture and allowed to heat at 90-95° C. for 2.5 hours till the yellow viscous oil was observed. The reaction mixture was cooled and water (500 ml) was added to it. The reaction mixture was allowed to reflux. The reaction mixture was then cooled and methanol (1000 ml) was added to it and further stirred at 0-5° C. The precipitated solid was filtered and washed with methanol. The product (99.0 g) with 95.8% of yield was formed and dried under vacuum.

### EXAMPLE 2

### Polymorph of Risedronate Sodium Form A at Room Temperature

Risedronic acid (2 gm) was suspended in 35 ml of water. Sodium hydroxide (0.3 gm) was added and the solution became clear within 1 hour. Acetonitrile was added to the solution. It was further cooled in ice bath for 2 hour. White colored solid product was filtered. It was washed with acetonitrile. It was dried under vacuum at room temperature for 2 hours. XRD data confirmed it to be Form A.

### EXAMPLE 3

### Polymorph of Risedronate Sodium Form A at Reflux Temperature

Risedronic acid (2 gm) was suspended in 35 ml of water. Sodium hydroxide (0.3 gm) was added and refluxed. Acetonitrile was added at reflux temperature to the solution. It was cooled to room temperature and further in ice bath. White colored solid product was filtered. It was washed with acetonitrile. It was dried under vacuum at room temperature. XRD data confirmed it to be Form A.

### EXAMPLE 4

### Polymorph of Risedronate Sodium Form B at Room Temperature

Risedronic acid (2 gm) was suspended in 35 ml of water. Sodium hydroxide (0.3 gm) was added and the solution became clear. Tetrahydrofuran was added to the solution. It was further cooled in ice bath for 2 hours. White colored solid was filtered. It was washed with tetrahydrofuran. It was dried under vacuum at room temperature for 2 hours. XRD data confirmed it to be Form B.

### EXAMPLE 5

### Polymorph of Risedronate Sodium Form B at Reflux Temperature

Risedronic acid (2 gm) was suspended in 35 ml of water. Sodium hydroxide (0.3 gm) was added and refluxed. Tetrahydrofuran was added at reflux temperature to the clear solution. It was cooled to room temperature and further cooled in ice bath. White colored solid was collected. It was washed with tetrahydrofuran. It was dried under vacuum at room temperature. XRD data confirmed it to be Form B.

Certain modifications and improvements of the disclosed invention will occur to those skilled in the art without departing from the scope of invention, which is limited only by the appended claims.

We claim:

1. A process for the preparation of a polymorphic form of 3-pyridyl-1-hydroxyethylidine-1,1-bisphosphonic acid sodium salt comprising adding a sodium base in an aqueous suspension of 3-pyridyl-1-hydroxyethylidine-1,1-bisphosphonic acid, adding an organic solvent or a mixture of organic solvents of varying composition into the same at room temperature, optionally cooling the resultant solution up to 5° C. and obtaining the resultant solid of polymorphs.

2. The process according to claim 1, wherein the sodium base is selected from sodium hydroxide, sodium carbonate, sodium hydrogen carbonate or sodium alkoxide.

3. The process according to claim 1, wherein the organic solvent or the mixture of organic solvents are selected from the group comprising alcohols, amides, esters, ethers, ketones or nitriles.

4. The process according to claim 1, wherein the polymorphic form of 3-pyridyl-1-hydroxyethylidine-1,1-bisphosphonic acid sodium salt is preferably Form A and Form B.

5. The process according to claim 1, wherein the organic solvent, which is non-alcoholic is being added optionally at reflux temperature.

6. A process for the preparation of polymorphic Form A of 3-pyridyl-1-hydroxyethylidine-1,1-bisphosphonic acid sodium salt comprising:
(a) adding a sodium base in an aqueous suspension of 3-pyridyl-1-hydroxyethylidine-1,1-bisphosphonic acid;
(b) adding an organic solvent or a mixture of organic solvents of varying composition to the same at room temperature;
(c) optionally cooling the resultant solution to 5° C.; and
(d) obtaining the resultant solid of Form A of 3-pyridyl-1-hydroxyethylidine-1,1-bisphosphonic acid sodium salt.

7. The process according to claim 6, wherein the sodium base is selected from sodium hydroxide, sodium carbonate, sodium hydrogen carbonate or sodium alkoxide.

8. The process according to claim 6, wherein the organic solvent or the mixture of organic solvents are selected from the group comprising alcohols, amides, esters, ethers, ketones or nitrites.

9. The process according to claim 8, wherein the organic solvent is selected from ketones group in the range of about 15%-50% in resulting reaction solution.

10. The process according to claim 9, wherein ketones are selected from acetone (20%-40%), methyl ethyl ketone (20%-50%), methyl isobutyl ketone (15%-20%) or the mixture of ketones (15%-40%).

11. The process according to claim 8, wherein the organic solvent is selected from nitrile group in the range of about 15%-40% in resulting reaction solution.

12. The process according to claim 11, wherein nitrile is acetonitrile (15%-40%).

13. The process according to claim 8, wherein the organic solvent is selected from ether group in the range of about 15%-40% in resulting reaction solution.

14. The process according to claim 13, wherein ethers are selected from tetrahydrofuran (15%-40%), dioxanes (15%-20%) or the mixture of ethers (15%-25%).

15. The process according to claim 8, wherein the organic solvent is selected from ester group in the range of about 20%-50% in resulting reaction solution.

16. The process according to claim 15, wherein ester is ethyl acetate (20%-50%).

17. The process according to claim 8, wherein the organic solvent is selected from amide group in the range of about 15%-20% in resulting reaction solution.

18. The process according to claim 17, wherein amides are selected from dimethyl formamide (15%-20%), dimethyl acetamide (15%-20%), 1-methyl-2-pyrrolidinone (15%-20%) or the mixture of amides (15%-20%).

19. The process according to claim 8, wherein the organic solvent is selected from alcohol group in the range of about 15%-40% in resulting reaction solution.

20. The process according to claim 19, wherein alcohols are selected from ethanol (15%-25%), methanol (15%-25%), isopropanol (15%-40%) or the mixture of alcohols (15%-25%).

21. The process according to claim 6, wherein the organic solvent, which is non-alcoholic, is being added optionally at reflux temperature.

22. A process for the preparation of polymorphic Form B of 3-pyridyl-1-hydroxyethylidine-1,1-bisphosphonic acid sodium salt comprising:
(a) adding a sodium base in an aqueous suspension of 3-pyridyl-1-hydroxyethylidine-1,1-bisphosphonic acid;
(b) adding an organic solvent or a mixture of organic solvents of varying composition to the same at room temperature;
(c) optionally cooling the resultant solution to 0-5° C.; and
(d) obtaining the resultant solid of Form B of 3-pyridyl-1-hydroxyethylidine-1,1-bisphosphonic acid sodium salt.

23. The process according to claim 22, wherein the sodium base is selected from sodium hydroxide, sodium carbonate, sodium hydrogen carbonate or sodium alkoxide.

24. The process according to claim 22, wherein the organic solvent or the mixture of organic solvents are selected from the group comprising alcohols, amides or ethers.

25. The process according to claim 24, wherein the organic solvent is selected from ether group in the range of about 40%-75% in resulting reaction solution.

26. The process according to claim 25, wherein ethers are selected from tetrahydrofuran (50%-70%), dioxanes (40%-75%) or the mixture of ethers (50%-75%).

27. The process according to claim 24, wherein the organic solvent is selected from amide group in the range of about 40%-60% in resulting reaction solution.

28. The process according to claim 27, wherein the amides are selected from dimethyl formamide (40%-60%), dimethyl acetamide (40%-60%), 1-methyl-2-pyrrolidinone (40%-60%) or the mixture of amides (40%-60%).

29. The process according to claim 24, wherein the organic solvent is selected from an alcohol group in the range of about 40%-80% in resulting reaction solution.

30. The process according to claim 29, wherein the alcohols are selected from ethanol (40%-80%), methanol (40%-75%), isopropanol (55%-75%) or the mixture of alcohols (40%-75%).

31. The process according to claim 22, wherein the organic solvent is being added, which is non-alcoholic, optionally at reflux temperature above 80° C.

32. A process for preparing risedronic acid comprising reacting 3-pyridyl acetic acid with phosphorous acid and phosphorous trichloride in the presence of chlorobenzene, adding water to the reaction mixture without decanting or separating chlorobenzene, heating the resultant reaction mixture and adding methanol into the same to obtain solid risedronic acid, and the solid risedronic acid thus obtained is further used in the preparation of the risedronate salt and its polymorphs in accordance with the process recited in any of claims 1, 6 or 22.

33. The process according to claim 32, wherein the reaction is carried out at a temperature of 90-95° C.
